(19) United States
(12) Patent Application Publication
(10) Pub. No.: US 2020/0346235 A1
(43) Pub. Date: Nov. 5, 2020

(54) DISPENSERS

(71) Applicant: RIEKE PACKAGING SYSTEMS LIMITED, Leicester Leicestershire (GB)

(72) Inventor: Simon Christopher KNIGHT, Bridgend Mid Glamorgan (GB)

(21) Appl. No.: 16/931,767

(22) Filed: Jul. 17, 2020

Related U.S. Application Data
(63) Continuation of application No. 15/779,313, filed on May 25, 2018.

(30) Foreign Application Priority Data
Nov. 27, 2015 (GB) 1520997.6

(51) Int. Cl. B05B 11/00; A47K 5/12

(52) U.S. Cl. CPC B05B 11/3059; B05B 11/3023; B05B 11/3047; A47K 5/1205; B05B 11/3067; B05B 11/3074; A47K 5/12; B05B 11/306

(57) ABSTRACT

A dispenser has a plunger (3) operable in a pump body (4). The plunger can be locked up or locked down, and formations (88,89) of a pump plunger stem and pump body insert (6) for achieving this are described. Components of the dispenser, including a pump body cylinder/closure component (5), container neck and a pump body insert (6), are rotationally locked together with non-selective alignment and sealed by sliding-fit seals to prevent damage or leakage caused by relative turning of the components in transit.

### FIELD OF THE INVENTION

This invention has to do with dispensers for liquid products, of the type in which a pump consisting essentially of moulded plastics components is mounted on the neck of a container of a liquid to be dispensed, and dispenses the liquid by an action in which a plunger of the pump is moved relative to a body of the pump. Such dispensers are widely used e.g. for dispensing soaps, cosmetics, toiletries, medical creams, lotions and the like.

### BACKGROUND

Generally, pumps of the kind to which the present proposals relate have a pump body with an inlet to a pump chamber and an outlet passage from the pump chamber to an outlet opening. An inlet check valve assures directional flow, and usually an outlet valve is provided for adequate priming and re-fill of the pump chamber. The pump chamber is varied in volume by movement of the plunger, and usually is defined between a piston and cylinder; typically the piston is carried by the plunger and wipes the inside of a cylinder which is part of the pump body. The simplest, and hence most economical and popular, designs have the outlet passage through the plunger and that is the preferred type here. Preferably a pump spring biases the plunger to an extended position (up-position) relative to the body, at maximum pump chamber volume. The user depresses the plunger against this spring to reduce the pump chamber volume, close the inlet valve and drive product out through the outlet passage. In this description we describe pumps as with the plunger movement axis upright and the plunger at the top of the body (the position of full depression of the plunger then being the down-position), for ease of description and because it is preferred and normal, but the skilled person will understand that other orientations are possible. The terminology is relative and not absolute.

It is well-known to enable locking of the plunger axially relative to the body, especially for shipping purposes for which the locked-down position is more compact. Usually lock-down is by depressing and then turning the plunger, bringing interlock formations such as screw threads or lugs/slots into engagement. Other pumps provide for locking-up at full extension, preventing depression of the plunger. This may be e.g. for aesthetic reasons, or to avoid dispensing an unwanted dose by pushing the plunger down before locking. Some pumps provide for both up-locking and down-locking.

In general, pump dispensers nowadays are required to withstand more and more demanding shipping and transit conditions, including sending individually e.g. as mail packages. Shaking, inversion, impact and temperature changes can provoke leakage, either through small clearances and tolerances in the pump structure or by accidental detachment, damage or unlocking of the components.

At the same time there is a prevailing requirement that such mass-produced articles should consist of as few parts as possible so as to be economical to make. These are challenging demands.

### The Invention

In these proposals we put forward new features of dispensers and dispenser pumps of the kind described, with a view to addressing the above issues.

### General Dispenser Features

The primary features of pump dispensers of the kind which the invention relates have already been described above.

Typically the pump or pump module is a discrete module connected to a container neck, with all or part of the pump body projecting down inside the container interior. The pump module may comprise a closure portion which engages around the neck to close it so that liquid outflow is through the pump, and engages it to hold the pump module and container together. The body normally also comprises a cylinder portion, with a cylinder wall and inlet formation to provide a pump chamber in cooperation with a piston of the plunger. A cylinder portion and closure portion may be formed in one piece, as a cylinder/closure component (“cylinder body” for short). Usually a discrete outer securing cap is provided, adapted to fix down onto the container neck e.g. by a thread or snap engagement, to hold the body in place, having an opening through which the plunger projects, and optionally a top portion of the pump body too such as of a cylinder or collar described herein.

The pump body may have internal features inside the cylinder portion to provide various features, and for this it is usually necessary to provide a discrete insert component fitting into the cylinder portion from above, because of moulding constraints.

The pump body may have a collar portion around where the plunger emerges from an opening of the body, providing one or more functions such as sealing, locking and the like between the body and plunger at the exterior. This collar will usually overlap the interior void of the cylinder portion so that again, because of moulding constraints, it is often made as a discrete component fixed to the cylinder portion or closure portion. In preferred embodiments herein an insert portion or collar portion are combined in a single collar/insert component (“body insert” for short) part of which (insert) extends down inside the cylinder portion, part of which (collar) is above at the pump exterior.

An insert portion or combined body insert may for example have formations providing any one or more of uplocking and/or downlocking in relation to a stem of a plunger, a seat for a pump spring, and one or more seals to engage the plunger as discussed later. Usually it is fixed axially into the cylinder portion or closure portion e.g. by a snap fit.

The inlet valve may be of any kind, but typically is a ball valve. The inlet may have a dip tube fitting e.g. socket, holding a dip tube which extends down into the container interior.

Typically the plunger is of the kind incorporating the outlet passage and outlet opening, i.e. a “moveable nozzle” pump. Usually the plunger has a head on which the user presses and where the outlet opening is provided (e.g. at the end of a laterally-projecting nozzle), a stem projecting axially down from the head into the pump body through an opening thereof, and a piston on the stem engaging the wall of the cylinder portion with a pump seal. The lower end of the stem has an entry to the outlet passage below the piston seal, i.e. in the pump chamber, which opens in the down-stroke of the plunger. An outlet valve function may be provided by a moveable valve body, e.g. a conventional ball valve in the outlet passage of the plunger. More preferably it is provided by slidable mounting of pump seal/piston on the stem, in which a sleeve mounting of the piston covers or uncovers one or more entry windows to the outlet passage according to the relative position of the piston, which moves up relative to the stem on the downstroke and vice versa.

Preferably the plunger head has one or more dependent skirts coaxial with the plunger stem. In preferred embodiments one of these is an inner plunger skirt which extends down into the pump body, entering the top opening of the pump body even in the up-position of the pump, and contains or surrounds a pump spring and whose top end presses up against the underside of the plunger and bottom end presses down against a spring seat formation in the pump body, e.g. in a cylinder portion or insert portion of the body.

The cylinder portion of the pump body may have a vent opening for admitting compensation air into the container, positioned above the pump seal in the down-position, and which desirably is blocked e.g. by the piston/pump seal in the up-position.

Preferably most or all of the pump components are made from polypropylene (PP). A flexing seal element, such as a piston pump seal, may be of softer material such as LDPE. The container material is not critical but may be e.g. HDPE.

The volume dispensed per stroke may be any conventional amount, but typically is between 0.5 and 20 ml, more usually between 1 and 10 ml or between 1 and 5 ml.

The outlet opening may be sealed for shipping with a bonded film or foil (e.g. inductively bonded), which can be pulled away before use and provides additional shipping security and tamper-evidence.

Specific novel proposals are now described in general terms. While each of them individually can provide novel and useful operation of an individual part of a pump or dispenser, they also work in concert and are proposed herein in any compatible combination.

In one general conceptual feature we propose a greater degree of rotational locking between components of the dispenser, in combination with the use of plug-type sliding seals between dispenser components, engageable in the up-position and/or in the down-position, one or both of which positions is lockable by means of a locking mechanism provided in the pump. This combination of features inhibits certain kinds of relative movements between pump components which, in known pumps, can disrupt internal seals, joins and external packaging. A combination of rotationally-locked joints which connect by axial sliding push, with axially-sliding or plug seal engagements between different components of the pump enabling these axial connections to be made, provides for novel dispensers and novel pumps with a high degree of shipping security.

Other novel and characteristic proposals herein include new water guard or shower guard structures for keeping external water out of the pump interior, and a new mechanisms for preventing rotation (e.g. leading to unlocking) of the plunger relative to the body, especially with tamper evidence.

The preferred dispensers have pumps which can be locked in both the up-position and the down-position. Specific mechanisms and structures enabling both up-locking and down-locking are an independent aspect of the proposals herein.

Other proposals herein provide advantageous ways of combining multiple described functionalities into single moulded components, so that the component count of the pump/dispenser is low.

### (1) Container/Closure Joint

This proposal relates to the connection between the neck of the container and the closure or coupling portion of the pump body. In many conventional pumps the circular edge of the container neck presses up against the underside of a closure plate, and is clamped down against it through a compressible seal by a snap or threaded retainer/cap around the container neck. A first part of this proposal is that the container neck makes a plug fit or sliding seal with the closure portion. The closure portion may have inner and outer dependent skirts defining a channel between them into which the edge of the container neck fits with interference. The container neck edge may have a cylindrical surface which makes a sliding seal against a corresponding cylindrical surface of a skirt, such as a flexible or deformable skirt, depending from the closure.

A second part of the proposal disclosed for the container/closure joint is a rotational interlock. The container neck edge and the joint part of the closure which engages it have respective rotational interlock formations which overlap axially in a circumferential direction, to prevent relative rotation of the joined parts. Thus, one or both components may have one or more—preferably a circumferential series—of projections and/or recesses, engaged by one or more corresponding projections and/or recesses of the other component at the joint. These formations may be provided adjacent a push or plug sealing formation as described, and desirably are engageable by axial pushing together of the container and closure accompanying formation of the plug seal. Desirably the engagement can be made at more than two, preferably more than five and most preferably more than ten different rotational relative alignments of the two components, so that specific alignment of components is not needed in assembly. This can be assisted by tapering lead formations on the lugs and/or recesses.

Thus, the container neck may have a cylindrical sealing edge and a circumferential array of rotational lock projections projecting from the inside or outside—preferably outside—surface thereof, preferably below its extreme edge to allow it to flex. Correspondingly, the closure may have two radially-spaced skirts with a channel between, one (preferably the inside) being smooth and preferably deformable, to make the plug seal, and the other being stiffer or rigid and including one or more projections into the channel to interlock with the corresponding recesses of the bottle neck.

Without requiring extra components, this proposal strongly inhibits rotation of the pump module relative to the container, which is one type of movement apt to disrupt packaging and cause leakage. Especially it is advantageous in concert with other features i.e. when the pump body closure portion is integral with and/or a rotationally locked to other pump body portions, specifically a cylinder portion, insert portion and collar portion or such of these as are present.

### (2) Plunger/Body (Collar) Interlock

Another feature useful for preventing leakage, in a pump providing at least a down-lock capability, is to provide a rotational interlock engagement between the plunger and the body, inhibiting rotation which could release the down-lock and/or disrupt outer packaging etc. Such a function is known in itself, but in the present proposal is desirably provided in combination with any one or more or all of the other proposals herein. The engagement is desirably between an underside of the plunger head and the pump body, preferably with a collar portion of the pump body. Means for this are already known per se, such as in our PCT/GB2015/052021 the contents of which are hereby incorporated by reference, and in earlier publications. Two novel proposals for plunger/collar interlock are proposed herein.

In a first proposal, one of the plunger head underside and the collar has an annular array of circumferentially-spaced projections directed towards the other, and the other component has one or more projections engageable with those of the first component so that, when they are pushed axially together, rotation is prevented or inhibited. As with the container/closure interlock discussed above it is desired to have low rotational selectivity to facilitate assembly, so desirably the series of projections allows for interlocked engagements at five or more, preferably ten or more different rotational alignments. The series of projections may be provided around the edge of a skirt projecting from one component towards the other, e.g. an upward skirt projecting from the collar towards the underside of the plunger head. One or more corresponding projections, such as one or more downward ribs on the underside of the plunger head, can engage beside these projections in the down-position. Preferably the interlock engagement is covered in this position, and more preferably covered also in the up-position, e.g. by another skirt or counter-skirt projecting from the other component and surrounding the skirt having the one or more projections. These may be the skirts of a preferred water guard feature discussed below under (9).

A second proposal for rotational plunger interlock can be in the form of tamper-evident (single use) feature. A circumferential arcuate rib body (circle segment) depends from the plunger underside, and fits downwardly into a corresponding arcuate groove of the collar. The rib and/or groove may have overhang formations, such as a barb, pawl or convergent cross-section, whereby the rib cannot be pulled axially out of the groove after insertion. The rib may connect to the plunger through one or more frangible links so that it will break away when the plunger is turned or pulled with sufficient force to release it, e.g. to turn it to an unlocked position so it can rise. Desirably the notch in the collar is circumferentially longer than the rib so that the plunger can be turned (e.g. for downlocking) after depression and engagement of the rib in the groove, on assembly of the product. The groove may also have a circumferentially-directional barb or stop preventing the rib from returning along the groove in the reverse direction of installation, so that it must break away when the plunger is turned towards unlock.

Both these proposals have the advantage of allowing axial overlap (rotational engagement) of the interlock formations between plunger and body collar on depression and turning of the plunger e.g. to a locked-down condition.

(3) Internal Body Interlock (Collar/Insert with Cylinder/Closure)

A further proposal to inhibit the disruption of internal seals and also to inhibit relative rotation of components from the outside (especially in combination with other rotational interlocks) relates to the internal structure of the pump body. As mentioned, this body usually must be provided as more than one component in order to mould the desired functional features. For example, an insert portion may be a component separate from a cylinder portion. More preferably a collar portion and insert portion are integrally moulded as one component, separate from the cylinder portion which may also be integrally moulded with a closure portion. The present proposal is for rotational interlock between such discrete pump body components. Especially by a combination with rotational interlock between container and body, as in (1) above, and rotational interlock between plunger and body e.g. as in (2) above, security through the pump structure can be provided holding the components in rotational alignment which not only helps to protect internal seals against movement and leakage, but also inhibits gross relative movements of the components which might disrupt external seals, wraps or packaging.

For axial connection, the insert portion may have a snap connection into a cylinder portion as is known. This does not normally itself prevent relative rotation. Accordingly, the present proposal provides, on at least one of the insert portion and cylinder portion where they engage one another, a circumferential series of one, two or multiple projecting lugs with intervening recesses, engageable by one, two or multiple corresponding projections on the other components. As with the rotational interlock formations discussed above, it is preferred that rotational alignment is not selective, and that the interlocking engagement can be reached at more than one, preferably more than five, preferably at least ten different rotational alignments of the insert and cylinder portions. Preferably an upper part of the insert has a circumferential series of radial projections, such as short axial ribs or the like, which can be pushed down into corresponding recesses, slots or the like formed around the inside of a top opening of the cylinder portion, or a region where a cylinder portion joins integrally to a closure portion of the body. This rotational interlock may be formed above a snap engagement between the two components which provides the axial connection.

### (4) Uplock/Downlock Mechanisms

Desirably uplock and/or downlock is provided in the pump by engagement between respective formations on the plunger stem (or piston) and the inside of the body cylinder portion, especially in an insert portion in the body cylinder portion. These formations are desirably engageable by relative rotation around the plunger axis between the plunger and body/insert. For downlock, the body provides a downwardly-directed abutment (downlock abutment) beneath which a corresponding abutment such as a projection on the plunger stem can be turned to hold it down. (Circumferentially) beside the downlock abutment is a clearance, track or slot leading axially and allowing the abutment/projection of the stem to escape upwardly (typically under spring bias) when they are turned out of engagement. The abutment may be circumferential shelves or shoulders, optionally with inclined cam surfaces (such as threads) to cause tightening on turning.

Similarly for uplock: desirably the body/insert provides an upwardly-directed abutment (uplock abutment) such as a shoulder, shelf or cam surface, and the plunger stem has a corresponding downward abutment e.g. on a projection which can be rotated into or out of engagement with it, and an axial clearance or track is provided next to the uplocking abutment so that when turned out of engagement, the plunger can be depressed past it to the down-position.

By providing these uplock and/or downlock mechanism formations within the cylinder portion, such as in or on an insert portion of the body, they are recessed inside the pump structure and allow adaptations of the pump structure above, in particular the provision of a water guard or plunger stem seal above, to keep water or other contaminants out of the pump.

For example, in one preferred construction herein for a pump with both uplock and downlock capability, a body insert portion—desirably integral with a body collar portion—has a portion, e.g. tubular portion, with an inwardly-directing face providing—desirably on the same inward projection—an upward abutment or shoulder and a downward abutment or shoulder (uplocking and downlocking abutments), also desirably a turn stop for limiting the rotation of the plunger relative to the body insert in one direction (so that it is not unintentionally turned beyond the locked position). The inward projection may terminate at an axial clearance or axial path. Desirably these formations are multiple, e.g. similar formations are provided at opposite sides of the insert for additional security. Correspondingly, the plunger stem has a projecting downward abutment (uplock abutment) and upward abutment (downlock abutment), desirably respectively at the bottom and top of a single projecting formation, for engagement with the corresponding abutments of the body insert to provide the uplock and downlock positions. The corresponding projections on the stem can be dimensioned to pass through the mentioned axial clearance or axial path. A circumferentially-directed turn stop element should also be provided, according to the disposition of the corresponding turn stop on the body insert.

Since a turn stop may be required in both the uplock and downlock positions, preferably one of the components (either the insert or the plunger stem) provides a single turn stop for each set of formations while the other component, typically the stem, provides a pair of turn stop formations axially spaced from one another. Again, these sets of formations may be repeated around the stem.

The stem and insert may make a rotationally-varying contact engagement providing tactile feedback to a user rotating the plunger as to when their relative rotational alignment is at or approaching a stop point, i.e. one of the locked positions, and/or a tracking or operating alignment in which the stem can move freely through the insert for pumping of the dispenser. Such a rotationally selective engagement may additionally or alternatively stabilise the rotational alignment in any of these positions, e.g. by providing a local click or additional interference between the components at a rotational alignment position bordering a said position. In one novel proposal herein this may be by any one or more of elongate axial prominences, ridges or grooves on the exterior of the stem corresponding to circumferentially-localised diameter changes which are desirably progressive, i.e. ramped, curved or non-abrupt in the circumferential direction.

### (5) Down-Position Sealing

The presently proposed dispensers desirably have one, more or all of the following seal arrangements for preventing or inhibiting leakage with the pump in the down-position, especially when locked in the down-position such as for shipping or posting.

(a) Inlet seal. The bottom end of the plunger stem desirably has an annular seal which forms a seal around the body cylinder inlet, downstream of the inlet valve, in the down-position. Desirably this is a sliding seal with interference. Preferably the stem end has a projecting annular flexible sealing skirt to make the seal. It may engage within an inwardly-directed wall surface.

(b) Insert/stem seal. In many pumps the cylinder portion has a vent, communicating between the container interior and a space in the cylinder portion above the piston seal in the down-position so that it is open when locked down. This would provide a route for container contents to begin escape to the exterior through the pump mechanism. In embodiments herein having an insert portion of the body, desirably the insert portion has an inwardly-projecting support annulus or flange which mounts a stem seal lip e.g. in the form of a flexible skirt projecting upwardly. The plunger stem has a corresponding annular sealing surface which, as the plunger approaches the down-position, comes into sealing engagement with interference around this sealing lip. This sealing surface may be on the plunger stem above any uplocking/downlocking feature thereon. By having the sealing lip project upwardly relative to the bottom of the insert portion, clearance is provided for uplock and/or downlock formations on the insert interior to be provided below this sealing engagement.

(c) Stem seal (body/collar). Where the plunger stem emerges from the pump body, e.g. through an opening in a surrounding collar portion thereof, desirably an inwardly-projecting sealing lip is provided engaging the plunger stem. In particular, this is desirably a lip formed integrally in one piece with the pump body in general and a collar portion thereof in particular. In use of the dispenser this helps to prevent undesired entry of water, e.g. as a “shower guard”. It also provides a supplementary barrier to the escape of material during shipping/transit.

(d) Plunger skirt containment. As mentioned, preferred embodiments have a plunger with a dependent skirt extending down into the body, e.g. covering a pump spring. This skirt may have an outward lip at or adjacent its lower end which engages outwardly against the wall of the pump body, or cylinder portion or insert portion thereof. Also, in the down-position the bottom end of this skirt may reach down to an inward floor, flange, base or spring seat portion of an insert portion or cylinder portion, which most preferably also provides a stem seal as in (b) above. Such an extended skirt provides a containment space which may contain a pump spring and also may further contain any product eluding other seals.

(e) Piston seal/outlet seal. To prevent escape of liquid product from the pump chamber region through the outlet passage, desirably any outlet valve construction is closed off. In the present dispenser the preferred outlet valve construction is by means of a sliding sleeve incorporated with the piston seal, which engages a cylinder wall and covers or uncovers one or more entrance openings of the plunger stem. Normally the entrance opening is uncovered/open at the bottom of the plunger stroke (down-position) to allow liquid product into the outlet passage through the downstroke.

One first specific proposal is the provision of a piston stop abutment at the bottom of the cylinder portion, which engages the piston/sleeve component at the end of the downstroke to limit its downward movement relative to that of the plunger stem. The sleeve engages inwardly against the plunger stem along a slide track provided for it, and the plunger stem has a downward abutment limiting the slide of the sleeve. The piston stop is axially dimensioned such that when the plunger is locked down, the sleeve is held up with positive force by the piston stop against the downwardly-directed abutment of the stem, making a seal (generally a face seal rather than a sliding seal, to avoid sticking) that prevents fluid coming from above the piston (e.g. through the cylinder wall vent) and down into the outlet passage. The piston stop may itself be formed in the form of a closed surround wall, e.g. a cylindrical element upstanding from the bottom of the cylinder and making a continuous annular engagement against the underside of a radial web of the sliding sleeve component, which also inhibits fluid between these components.

### (6) Up-Position Sealing

With the plunger held or locked in the up-position, measures required for sealing are different from the down-position. The bottom of the stem is spaced up from the bottom of the cylinder. The plunger head rises clear of the body or body collar. If there is an insert/stem seal of type (5) (b) above, it must disengage if there are uplock or downlock formations on the stem which pass through this region. In our proposals, any one, more or preferably all of the following sealing measures are provided in or for the up-position.

(a) Piston/stem seal. Where the outlet passage entrance is controlled by a sleeve carrying the piston and operable to cover/uncover an entrance window of the stem, this sleeve may be positively held in its bottom limit position relative to the stem, in the up-position thereof. Thus, a top part of the sleeve or piston may engage an inward projection of the pump body, especially the bottom end of an insert portion, which in conjunction with the uplocking force holds a bottom annular edge of the sleeve in sealing contact with an upward annular seal portion around the outlet passage entrance window. Desirably this seal is with interference, i.e. one or both of the upward annular portion of the stem and the downward annular portion of the sleeve as a deformable lip with a slide surface against which a sliding engagement is made by the other component. This positively closes the outlet passage from the pump chamber. Energising force for the seal comes from predetermining the uplock position so that the sleeve is pushed up against the underside of the insert portion.

(b) Piston/insert seal. The mentioned piston-carrying sleeve may have a top annular seal portion which makes the sealing engagement with the underside of an inward projection from the cylinder body wall, especially the underside of an insert portion. Again, desirably this is a plug seal with interference, in which the top annular seal of the piston sleeve fits with interference against, into or around an annular counter-formation or sealing seat around the underside of the insert portion. This may of course be the same engagement that energises the seal at the bottom end of the sleeve portion described in (a) above. The combination of seals (a), (b) at the top and bottom of the piston-carrying sleeve blocks off both the pump chamber and the space above the piston from the outlet passage and from the internal space of the insert portion, without needing to seal against the stem itself.

(c) Vent seal. Preferably in the up-position any vent providing in the cylinder portion wall to allow venting air back into the container interior is blocked by the piston. For this purpose, preferably the piston has upper and lower lips which engage the cylinder wall above and below any such vent and prevent liquid getting from the container into the cylinder.

(d) Body/collar stem seal. Where the body, especially the collar thereof, has a sealing lip as proposed in (5)(c) to engage the stem in the down-position, desirably this same lip engages around a different portion of the stem (a lower portion of the stem) also in a sealing manner in the up-position.

### (7) Component Consolidation

To minimise the number of components, we have given attention to ways in which the various interlock and sealing functionalities—as well as the main pump functions—can be provided with a minimum of moulded components.

In one aspect of this, the plunger may have the head and stem formed in one piece. Generally this will mean that the bottom end of the stem is open as-moulded, and structure such as an end piece which plugs into or onto the stem end is desirable. In particular, the use of an end piece is consistent with the formation of one or more entrance windows to an outlet passage, with the retention of a sliding sleeve/piston on the end of this stem, and with the provision of upwardly-directed seal formations fixed with the stem (i.e. on the end piece) directed up towards opposed portions of the piston/sleeve component for sealing, which would be problematic with a stem moulding integrally closed at the bottom.

In an alternative aspect the discrete part of the stem is not just an end piece but a lower stem portion which comprises also the entrance to the outlet passage, and one or more uplock and/or downlock projecting formations on the stem exterior. This lower stem portion can plug fit, e.g. with a snap fit, into or onto an upper stem portion which may be integral with the plunger head. Desirably the interfitting parts of the upper and lower stem portions make a rotational interlock e.g. via axially-projecting lug or tooth forms, to ensure that rotation of the plunger head drives corresponding rotation of the uplock and/or downlock formations on the lower stem piece.

We also prefer that the body closure portion and cylinder portion are provided as a one-piece integral whole, i.e. a single moulding, the closure portion including the retaining formations to hold it onto the container edge, such as formations to establish a plug seal and/or rotational interlock discussed as discussed herein.

We also prefer that an insert portion of the body and a collar portion of the body are formed together in one piece, and are fixed to the other body portion e.g. as described herein. Since all of the above-mentioned rotational interlock and plug seal formations can be provided as integral extensions or formations of the mentioned components, essentially the entire pump of complex functionality can be provided with three main components, any end piece or stem piece needed for the plunger stem, and a spring. Especially for an uplock/downlock pump, this is a low component count.

### (8) Tamper-Evident Plunger Lock

The above proposal for the rotational locking of a plunger head to a pump body by an arcuate rib which can be inserted but not withdrawn from an arcuate groove is a novel proposal in itself for a plunger pump, in particular a pump with a downlocking mechanism.

### (9) Water Guard

We have already discussed above under (5) (c) the body collar having an integral sealing lip wiping against the plunger stem to keep water out. This is an economical proposal relative to e.g. constructions seen in our EP-A-2338607 where a separate external lip is attached to the collar, and is an independent proposal herein.

Another independent proposal herein for a water guard (e.g. a shower guard) for a plunger pump comprises an upward skirt from the body or body collar, and a downward skirt from the plunger head, these skirts surrounding the plunger stem and overlapping axially up to the up-position of the plunger, to shield the opening of the body where the plunger stem emerges. Desirably the skirt depending from the plunger fits outside (around) the skirt projecting up from the body. Preferably the skirts contact—although desirably without interference force—to minimise possible leakage between them.

The water guard feature desirably includes a drain whereby water running down the outside of the upward skirt (from the pump body) is led away from the bottom of the upward skirt. This drain desirably comprises one or both of a trough formation to collect any water flowing down the outside of the skirt, and a defined flow path to lead water away from the bottom of the skirt to a position outside the pump structure, particularly a position outside and below the opening of the pump body and/or outside and below any connection or joint between the collar portion of the pump body and a lower portion of the pump body such as a cylinder portion.

In a preferred embodiment a collar portion of the body comprising the upward skirt, which may be cylindrical, is formed integrally with an insert portion of the pump body that extends down inside a cylinder portion of the pump body. Desirably the collar portion defines a drain or trough structure integrally with the upward skirt. The trough structure may have one or more drain openings at the bottom. The collar portion may additionally comprise an outer wall structure around the trough. This outer wall trough may also provide a movement path for the downward skirt of the plunger head, and the outer wall may protect and mask the bottom edge of this downward skirt in the down-position of the plunger, enhancing security of the pump and dispenser.

### BRIEF DESCRIPTION OF THE DRAWINGS

Embodiments of our proposals are now described by way of example, with reference to the accompanying drawings in which:

FIG. 1 is a front oblique view of a pump in a first embodiment of the invention, without a container, in the down-position;

FIG. 2 shows the same pump in the up-position;

FIG. 3 and FIG. 4 are respectively longitudinal and lateral vertical sections through the pump in the down-position;

FIG. 5 is a longitudinal vertical section in the up-position;

FIGS. 6(a), (b) and (c) are respectively a longitudinal vertical section, a front oblique view and an oblique view from below of the plunger of the first embodiment;

FIGS. 7(a), (b) and (c) are respectively a top oblique view, and side view and a vertical section through a body insert component of the first embodiment;

FIGS. 8(a), (b) are respectively a top oblique view and a bottom oblique view of the body insert, to a larger scale;

FIGS. 9(a), (b) and (c) are respectively a bottom oblique view, a top oblique view and a vertical axial section through a cylinder body component of the first embodiment;

FIG. 10 shows a special form of container neck;

FIG. 11 shows an end piece of the plunger stem;

FIG. 12 shows a piston sleeve element of the plunger stem;

FIG. 13(a) is a side view of a pump of a second embodiment in the down-position, showing without a container, and FIG. 13(b) is a front view;

FIG. 14 is a side view of the second embodiment pump with a container constituting a dispenser, and in the up-position;

FIG. 15 is a longitudinal vertical section of the second embodiment pump in the down-position;

FIG. 16 is a vertical longitudinal cross-section of the second embodiment pump and container (dispenser) in the up-position;

FIGS. 17(a), (b) and (c) are respectively a bottom oblique view, and front view and a bottom view of the plunger of the second embodiment;

FIGS. 18(a) and (b) are a side view and a top view of the body insert of the second embodiments;

FIGS. 19(a), (b) and (c) are respectively a top oblique view, a bottom oblique view and an underneath view of the body insert of the second embodiment;

FIG. 20 shows a third embodiment of dispenser in a locked-down position;

FIG. 21 shows the third embodiment on a container and unlocked, with the plunger raised and a tamper-evident element broken away;

FIG. 22 is a vertical cross-section of the third embodiment in the down position;

FIG. 23 is a vertical cross-section of the third embodiment in the up position;

FIGS. 24(a), (b) and (c) are an underneath perspective view, an underneath view and a vertical section showing the plunger head and an upper stem portion of the third embodiment;

FIG. 25 shows the cylinder body from above;

FIGS. 26(a) and (b) are a perspective view and a sectional view of the sliding seal;

FIGS. 27(a)-(d) are respectively an upper perspective view, vertical sectional view, bottom perspective view and top oblique view of the body insert component of the third embodiment;

FIGS. 28 and 29 are vertical sectional views of a fourth embodiment in the locked-down position and the locked-up positions;

FIG. 30 is a sectional view showing the plunger head and upper stem portion of the fourth embodiment;

FIGS. 31(a) and (b) are a side view of a lower stem portion and a section through the lower step portion, showing uplock/downlock formations;

FIGS. 32(a)-(c) are a transverse section through the body insert at the level of the uplock/downlock formations, a vertical sectional view through the body insert, and an enlarged detail at the circled portion of FIG. 32(b) showing a spring seat portion, and

FIGS. 33(a)—(c) are a side view, top view and underneath view showing the upper part (closure portion) of the cylinder body.

### DETAILED DESCRIPTION OF EMBODIMENTS

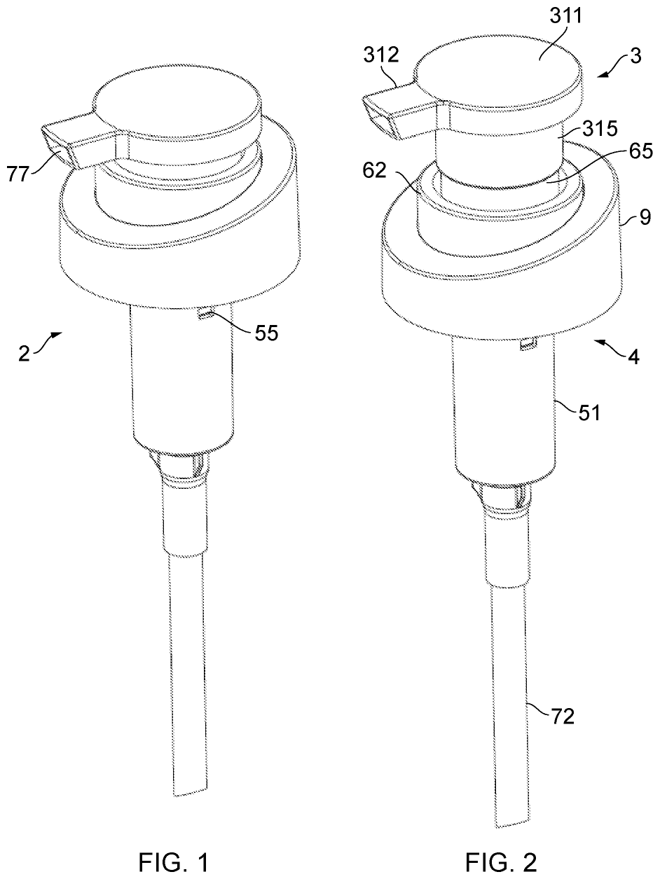

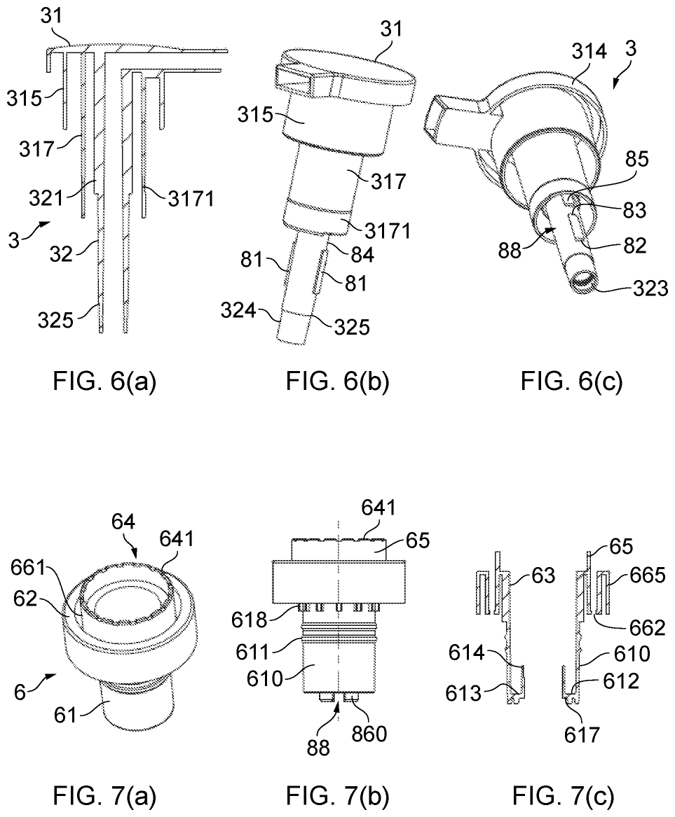

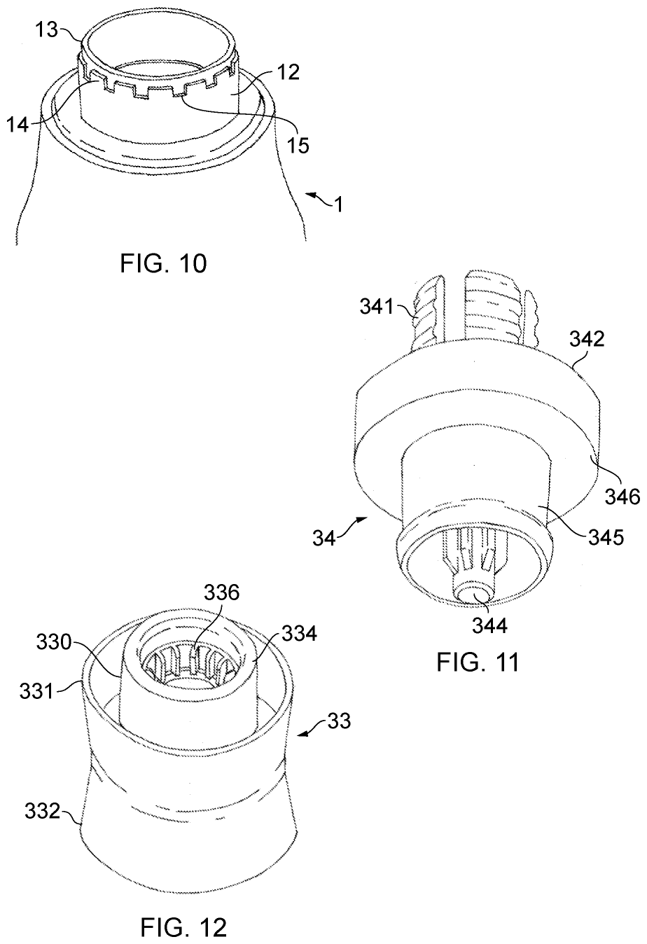

The pump module in a first embodiment of dispenser is described with reference to FIGS. 1 to 12. FIGS. 1 to 5 show the pump in “up” and “down” conditions from various viewpoints and sections, while FIGS. 6 to 12 show details of separate components. In FIGS. 1 to 5 the container of the dispenser is omitted, but the container 1 is shown in the second embodiment described later and the features are the same for the first embodiment, also details of the container neck for both embodiments are shown in FIG. 10. The general components of pump 2 are a pump body 4 and a plunger 3 reciprocable in the body in a pumping stroke. In this embodiment the pump body 4 is provided as a combination of two one-piece moulded components, namely a cylinder/closure component 5 (cylinder body) and a collar/insert component 6 (body insert). The cylinder body includes a cylinder portion 51 defining a pump chamber and a closure portion 52 by which the cylinder portion is mounted fixedly in the neck of a container 1. The drawings also show a surrounding trim piece 9; this is for shape styling at the top of the container 1 and otherwise non-functional.

The cylinder portion 51 has a cylinder wall 52 with a convergent inlet formation 53 at its bottom end defining a dip tube socket 531 for a dip tube 72 and an inlet valve 74 with a valve ball 75. Around the valve opening a cylindrical piston stop 54, in the form of a closed cylindrical wall, projects integrally up from the convergent bottom of the cylinder portion.

The closure portion 52, formed integrally with the cylinder portion 51 as a single moulding, consists of a generally circular closure plate 57 with a peripheral downward outer securing ring 59 and a longer and more flexible downward sealing skirt 58 spaced inwardly from it, defining a channel 581 between them. FIG. 9(a) shows that the outer securing ring 59 has a circumferential series of inwardly-projecting lugs or nibs 591. As shown in FIG. 10 the neck 12 of the bottle 1 has an annular edge 13 with a smooth cylindrical inner face and on the outside a series of locking lugs 14 and recesses 15 complementary to the lugs 591 on the closure securing ring 59. These components push together to make a plug seal, with interference and some deformation of the downward sealing skirt 58, to hold and seal the cylinder body 5 onto the container 1 with rotational interlock.

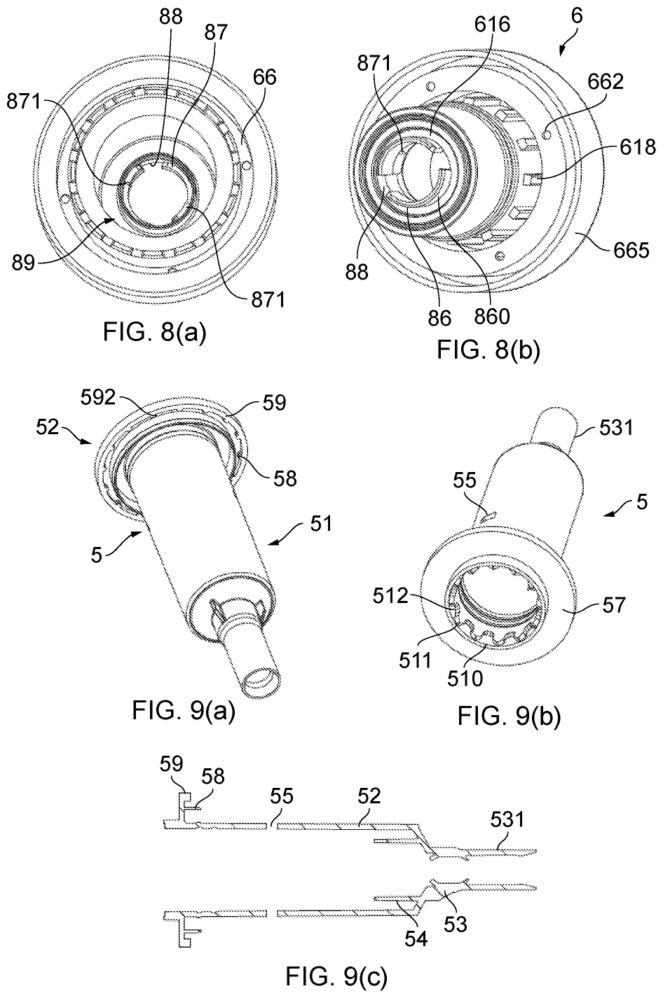

The insert portion 61 of the body insert 6 fits down closely with its tubular wall 10 inside the upper part of the cylinder wall 52, held in place axially by snap ribs 611 engaging corresponding recesses in the cylinder wall. At its bottom end, the wall of the insert portion 61 turns in with a flange or floor 612 which forms a spring seat 613 on the inside for the bottom end of a pump spring 71 (here, a metal coil spring). The inner periphery of the flange 612 carries an upwardly-projecting generally cylindrical sealing skirt 58, spaced in from the wall. The downward surface of the insert flange 612 has a downwardly-projecting annular projection 615 which is part of a sealing seat and surrounds and defines a channel 616 for a sealing engagement described later. With reference to FIGS. 7 and 8, the lower interior of the insert has a set of internal uplock/downlock formations 89 to be described later, and these include a pair of downward projections 860.

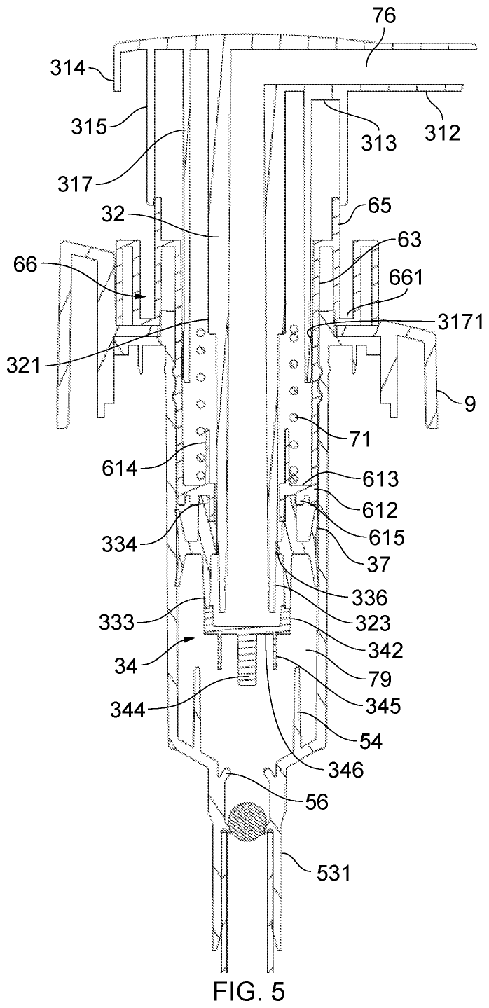

At its upper part, the insert 61 projects out through the top opening of the cylinder portion 51 with a tubular upward extension 63 (FIG. 5) which connects the cylinder integrally with a collar portion 62 of the body on the outside of the pump. The collar surrounds the upper part of the plunger 3, and the head 31 of the plunger fits down against the collar 62 in the down-position. In this embodiment the upward extension 63 connects to an axial cylindrical water guard skirt 65 with an exposed upper edge, and whose lower end connects integrally with a downward trough formation 661 with a series of holes 662 through it (FIG. 8(b)) forming part of a drain structure 66. The outer wall of the trough extends back up and meets at the top with a further trim wall, forming together an outer guard wall 665 opposed to the water guard skirt 65 across the trough 661.

Beneath the collar, at the outside of the tubular wall 610 at the upper part, above the snap rib 611, the insert 61 has a circumferential series of short outwardly-projecting axially-extending locking ribs 618. The cylinder body 5, at its opening part or mouth above the snap formations (see FIG. 9(b)) has an upwardly and inwardly open circumferential series of lugs 511 with intervening recesses 510 and the ribs 618 of the body insert 6 fit down into these, so that by combination of the snap rib 611 and the interlock formations 618,510,511 the body and insert are held axially and rotationally rigidly together.

The plunger consists of a head 31, with a flat press top 311 and a laterally-projecting nozzle 312, an axial stem 32, and a piston 33 carried at the lower end of the stem on a sliding sleeve 330 and providing a pump seal 37. In this embodiment the head 31 and stem 32 are moulded together as a single piece, defining an outlet passage 76 starting at an entry opening or window 78 at the bottom of the stem and finishing at an outlet opening 77 at the end of the nozzle 312. The perpendicular outlet passage parts can be moulded by means of a withdrawing mould element. The bottom end of the stem is then open, and forms an end socket 323 with internal snap ribs to receive a discrete end piece 34 (see FIG. 11).

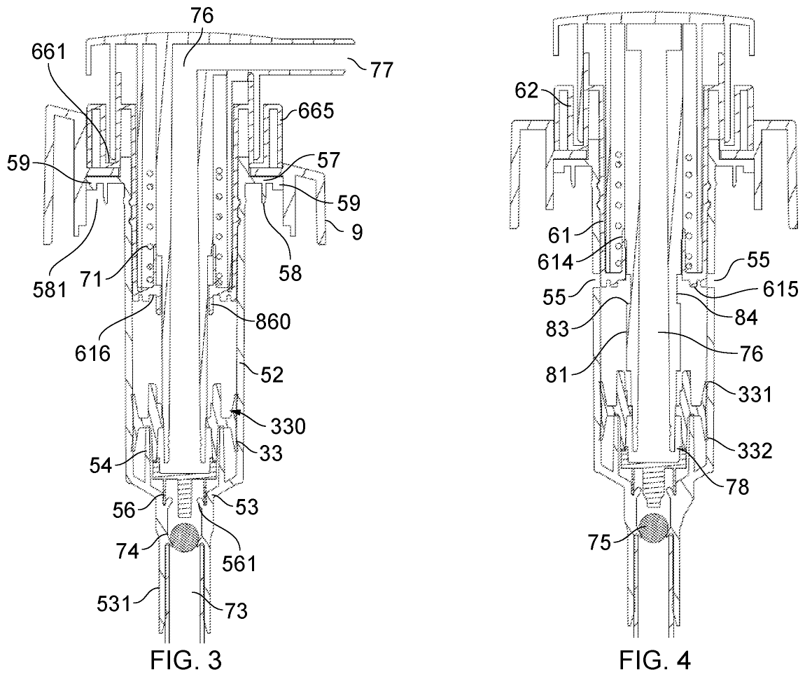

Integrally moulded cylindrical skirts extend down from the underside of the plunger. An outer skirt 314 is provided to contour the press top exterior. Next, an intermediate downward skirt 315 (water guard skirt) extends down between the upward skirt 65 of the collar 62, in sliding contact around it, and its bottom end projects down into the trough 661 of the collar so that in the down-position (FIGS. 3, 4) it reaches nearly to the bottom of the trough while the top of the collar skirt 65 reaches up and contacts the underside of the plunger, as discussed below. In the up-position (FIG. 5) the water guard skirt 315 still contacts and overlaps the upward collar skirt 65 from the outside, so that water landing on the dispenser is kept out of the pump mechanism and can fall down into the trough 661, from where it can drain through the holes 662 and away around the trim 9 which is not in a clamped sealing engagement, so water can leak away down around the outside of the closure 52. This combination of upward and downward skirts can function as a water guard with or without the outer wall structure 665 of the collar, but the latter helps to shield the joint line against tampering and damage.

Concentrically inward of the water guard skirt 315 an inner skirt 317 extends down from the plunger head, still at a radial spacing from the central stem 32. The inner skirt 317 fits closely through the top opening of the insert body, and has a slidable outward flare or lip 3171 at its bottom edge to wipe the inside surface of the insert body tube wall. The inner skirt is sufficiently long that in the up-position (FIG. 5) its bottom end (lip 3171) is still recessed into the insert body, while in the down-position (FIGS. 3, 4) it reaches the inward flange 612 at the bottom of the insert portion 61. In conjunction with the intermediate (water guard) skirt 315, the inner skirt 317 aligns the plunger during the dispensing stroke and also houses the spring 71, which reaches up inside the inner skirt 317 to act against the underside of the plunger head just below the nozzle 312.

The central stem 32 defines the vertical part of the outlet passage 76, up to the nozzle, and carries the piston (pump seal) 37 at its bottom end. It incorporates an outlet valve function by a slidable mounting of the pump seal piston 37 on the tubular sleeve 330. It also carries uplock and downlock stem formations 88 for the uplock/downlock mechanism and, at its bottom part, contributes to sealing in the down-position. The stem exterior has a larger-diameter top portion extending down with a smooth cylindrical surface sufficiently far to plug into the upward sealing skirt 614 of the body insert for the down-position stem/body seal—see FIG. 4 and also FIG. 5 where the corresponding seal region 321 of the stem is indicated.

Below this seal region 321 the stem surface is interrupted by uplock/downlock formations 88, specifically (see also FIG. 6) a turn stop projection 85 at an upper position, a keying projection 81 at a lower position and a circumferential slot or gap 84 extending between them. In this embodiment the turn stop and keying projections 85,81 are aligned one above the other, and repeated on the opposite side of the stem for extra stability and strength, but alternative arrangements are possible as the skilled reader will understand. The keying projection has a downward shoulder 82 for uplock and upward shoulder 83 for downlock, while for the turn stop projection 85 it is the lateral (circumferentially-facing) shoulder that is functional.

The corresponding uplock/downlock formations 89 of the insert are best seen in FIG. 8 and include an identical opposed pair of keying projections integral with the insert wall, separated by a pair of axial slots 88, each projecting down slightly below the end of the insert as downward projection 860. Each keying projection features an upward shoulder 87 for uplock and a downward shoulder 86 for downlock. At one end of the upward shoulder 87 a turn stop 871 projects up.

For operation of the pump, the stem keying projections 81 align with the axial slots or paths 88 of the body insert so that the plunger can move freely up and down. For downlocking the plunger is pushed right down until the upward shoulder 83 of the stem is below the downward abutment 86 of the body insert, and turned clockwise to bring them into line so that the insert holds the plunger down. After a predetermined degree of turn the side shoulder of the stem turn stop projection 85 meets the turn stop 871 inside the insert, preventing the plunger from turning too far and rising again through the other axial slot 88. To release the downlock the plunger is turned anticlockwise through the same angle.

For uplock, the plunger at the up-position is turned clockwise. The downward shoulders 82 of the stem keying projections 81 slide around and above the fixed upward insert shoulders 87 until turn is arrested by the sides of the keying projections 81 meeting the insert turn stops 871. The plunger is then held against depression, but can be released from the uplock by turning anti-clockwise until the keying projections 81 align again with the through slots 88. This uplock and downlock functionality is provided without any increase in the number of components beyond the basic elements.

The piston and other functions of the lower end of the stem 32 are now described. The bottom end of the stem has a reduced-diameter end portion 324 constituting a slide track for the sleeve 330 carrying the piston. A downward shoulder 335 forms a top stop of the slide track. The piston/sleeve element 33 (FIG. 12) has an inward annulus 336 that slides on the stem track 324, and a bottom seal ring 333 and top seal ring 334 which are each slightly spaced from the stem exterior. A pump seal 37 projects out around the sleeve 330 and has a top lip 331 and bottom lip 332 which engage sealingly against the cylinder wall; this component is desirably made of a softer material such as LDPE.

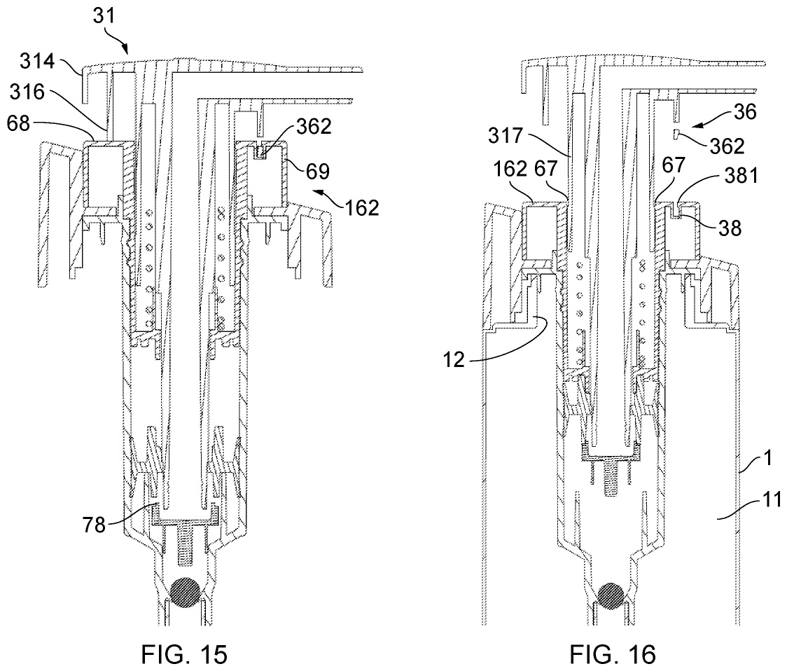

The bottom of the stem 32 is partly closed off by the end piece 34 (see FIG. 11). The end piece has a set of spaced clip legs 341 engaging the snap ribs inside the stem socket 323, a disc-shaped closure body 346 spaced slightly out from the stem end, and an upward seal ring 342. The underside of the closure body 346 carries a central nose 344 surrounded by a downward sealing skirt 345 which, in the down-position (FIGS. 3, 4), slidingly plugs sealingly into the inlet formation 53 of the cylinder body, around a cylindrical sealing surface 56 thereof, and stopped by inward nib projections 561, blocking communication between the inlet and the pump chamber 79. The piston sleeve 330 has limited travel between upper and lower positions relative to the stem 32. In the upper position (see also FIG. 15 of the second embodiment, where the structures are the same) the inward annulus 336 meets the top slide stop 325 and the bottom seal ring 333 of the sleeve 330 is axially spaced from the upward seal ring 342 of the end piece, leaving a window 78 for liquid product to enter the outlet passage through the bottom of the stem 32 during the downstroke of the pump, in which the piston sleeve takes the upper position because of friction against the cylinder wall. In the downward relative position of the sleeve seen in FIG. 5, the window 78 is closed by the bottom ring 333 of the sliding seal making a plug seal against the upward ring seal 342 of the end piece, which includes an internal deformable lip to make this a plug seal with interference. This isolates the pump chamber 79 from the outlet passage 76.

In the up-position (FIG. 5) the top seal ring 334 of the sleeve also plugs into the downward seal channel 616 of the body insert, between its sealing annulus 615 and the downward projections 860 which help to locate it, isolating the space above the pump seal 37 from the central opening of the body insert (which cannot be sealed directly at that position because the uplock/downlock formations must pass). In this position the pump seal 37 also blocks the side vent holes 55 through the cylinder wall, so that liquid cannot enter the cylinder from the container interior.

So, in both the up-position and the down-position, and in particular when the corresponding uplock and downlock mechanisms are actuated, the pump structure provides a set of internal seals preventing the entry of container liquid into the pump, and preventing the escape of any liquid already in the pump to the exterior of the pump.

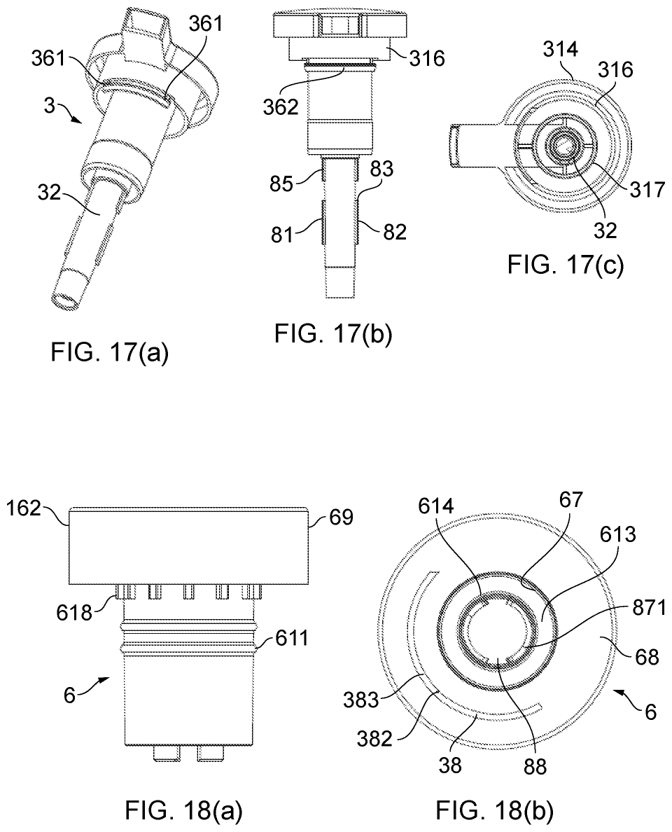

As part of the pump, and again without increasing the component count, means are provided for inhibiting rotation of the plunger 3 relative to the body 2. This can help to keep the pump in the down locked condition. In shipping, it also helps to prevent relative rotation which, as mentioned, may disturb internal seals or damage packaging. In this embodiment a plunger lock inhibiting release of the downlock mechanism is provided by interlock formations 64 acting between the top edge of the upward water guard skirt 65 of the collar 62 and the underside of the plunger head. As seen in FIG. 7, the top edge of the upward collar skirt 65 has a series of castellations 641, i.e. multiple upward block-form projections with slots between, slightly narrower than the projections. The top corners of these are slightly chamfered or rounded. This formation 64 is engaged in use by a downwardly-projecting radially-extending rib 313 of the underside of the plunger head, in line with the nozzle—see FIG. 5 (and also FIG. 17(c) of the second embodiment showing a corresponding rib, although it is not functional in the second embodiment). More than one rib may be used, but frequently the lowermost counter-surface beneath the head will be the surface beneath the nozzle and a single rib is convenient. When the plunger is pushed down and turned to the downlock position on assembly, the rib can easily engage into one of the slots between the many castellations 41, without positional selectivity. This interlock then inhibits unintended rotation of the plunger back out of the downlocked position. Conveniently, the interlock formations are completely hidden inside the water guard skirts 65,315.

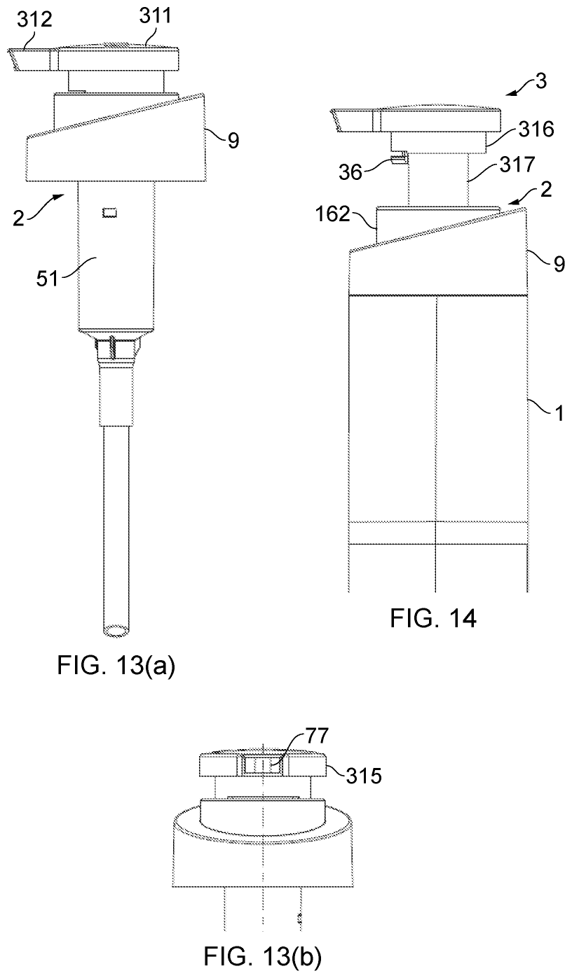

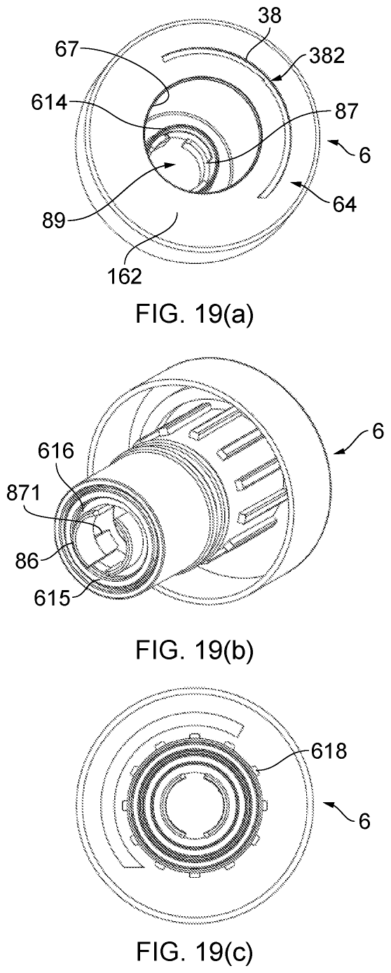

FIGS. 13 to 19 show a second embodiment. The elements of the pump, rotational interlocks and seals are all as in the first embodiment and are indicated by corresponding reference numerals, except that the structure and relation between the underside of the plunger and the top of the collar differ.

Firstly, the water guard function is provided not by a pair of opposing skirts, but by an integral seal lip projection 67 around the mouth opening of the collar 162, directly wiping the cylindrical outer surface of the inner skirt 317 of the plunger. This supplements the sealing or containment effect already provided by the bottom end of this inner skirt 317 sliding down the interior of the body insert.

Instead of the rotationally non-selective rotational interlock between the collar top and plunger underside in the first embodiment, the second embodiment provides a rotationally-selective rotational interlock which also constitutes a tamper-evident feature of the dispenser. An intermediate downward skirt 316 from the plunger is shorter in length than in the first embodiment, so that in the down-position of the pump (FIG. 15) its bottom edge just meets the flat upper surface 68 of the collar 162. Over a specified sector (between a quarter and a half of the full circumference) of the top surface 68 of the collar 162 is an arcuate locking groove 36 which, at least over a trap region 383 thereof (FIG. 18(b)) has an overhanging top lip 381 (FIG. 16). At a corresponding radial position beneath the nozzle 312 of the plunger, the intermediate skirt 316 carries a dependent break-off element 36 consisting of an arcuate rib body 362 connected to the skirt edge above through a pair of frangible links 361 (see FIGS. 17(a),(b)). The rib body 362 tapers downwardly in section (FIG. 16) so that on assembly it can be pushed with a snap down into the groove 38. The groove 38 is sufficiently long (FIG. 18(b)) that the plunger head can then be turned to the downlocked position, with the rib 361 sliding along the groove 38 internally, and moving past a barb or tooth 382 projecting across the groove 38 (FIG. 18(b)) and delimiting the trap zone 383. The rib body 362 cannot travel back pass the tooth/barb 382 and holds the plunger head in the downlocked rotational position. To release the plunger head to undo the downlock the frangible links 361 must be broken, leaving the broken-away rib body in the groove 38. As well as retaining the locked and sealed condition of the pump for shipping and transit, this also provides a visual tamper-evident feature.

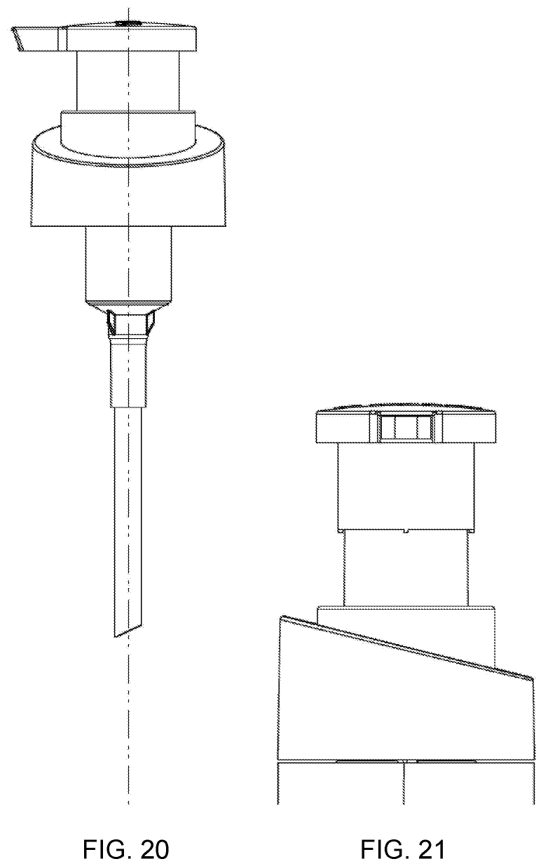

FIGS. 20 to 27 show a third embodiment, in which again the general components correspond to those of the first two embodiments but with the following differences.

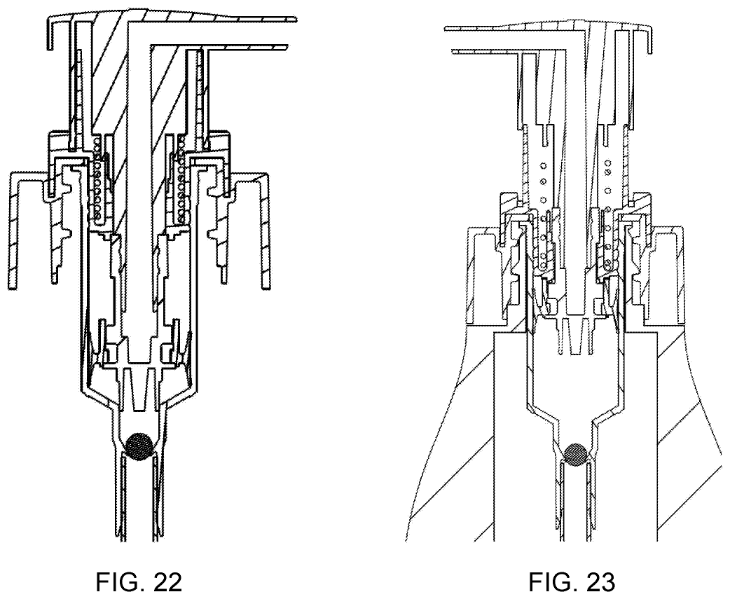

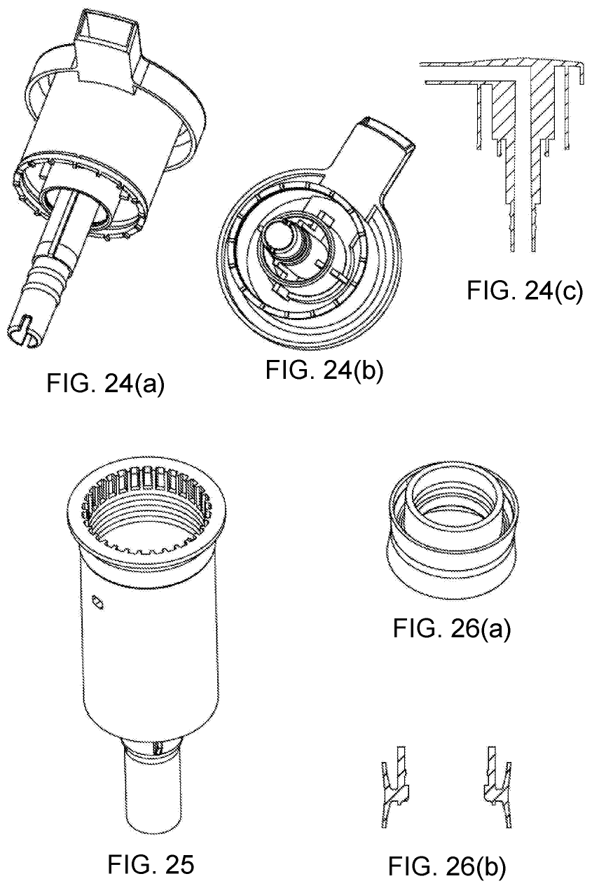

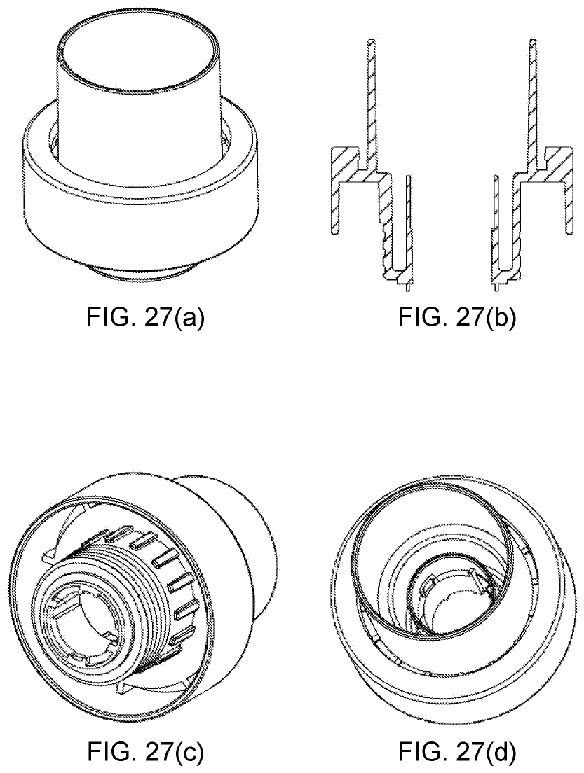

Firstly, the plunger stem is formed with an upper portion—integral with the plunger head as seen in FIG. 24—and a separate lower stem portion which snaps onto the upper stem portion. The lower stem portion carries the opposed pair of uplock/downlock rectangular lands, the top and bottom surfaces of which provide the down-locked and up-locked positions shown in FIGS. 22 and 23, by engagement with the inward projections on the insert component (FIG. 27). As before, the insert component lockdown formations include tracks for passage of the lands on the plunger stem, and stop formations, which are engaged by the ribs seen on the sides of the upper stem portion (FIG. 24). By providing the uplock/downlock formations on a separate stem piece, moulding of the stem and head components is simplified. The lower stem portion keys rotationally with the upper stem portion so that it will always turn with it.

This embodiment has a simpler structure for the annular seal protection on the end of the stem, which plugs into the inlet structure above the inlet ball valve in the down position (FIG. 22).

A further difference is an upward inner extension of the body insert (see also FIG. 2(a)), which—see FIG. 22—makes a seal in the down-position with a downward inner skirt beneath the plunger top.

A further difference is in the tamper-evident component. See FIG. 24(a)—a breakoff ring goes all the way round the bottom of the plunger's outer skirt, connected by a few frangible links. It fits into a corresponding annular trough which goes all the way round the top of the bottom collar: see FIGS. 27(a), (b), (d). The bottom of the breakoff ring has downward teeth which engage corresponding upward teeth (FIG. 27(d)) in the trough to prevent relative rotation. A downward tooth around inside the trough (see FIG. 27(b)) holds the ring down after initial forced insertion, so that the plunger cannot be turned or lifted without breaking the frangible links. This construction provides a barrier against initial unlocking of the plunger, and also a tamper-evident feature which can be neater than the second embodiment (above) in that a trough is filled with the detached breakoff ring all the way round.

The body insert locks rotationally into the top of the body cylinder in the same manner as before: see FIGS. 25 and 27(c).

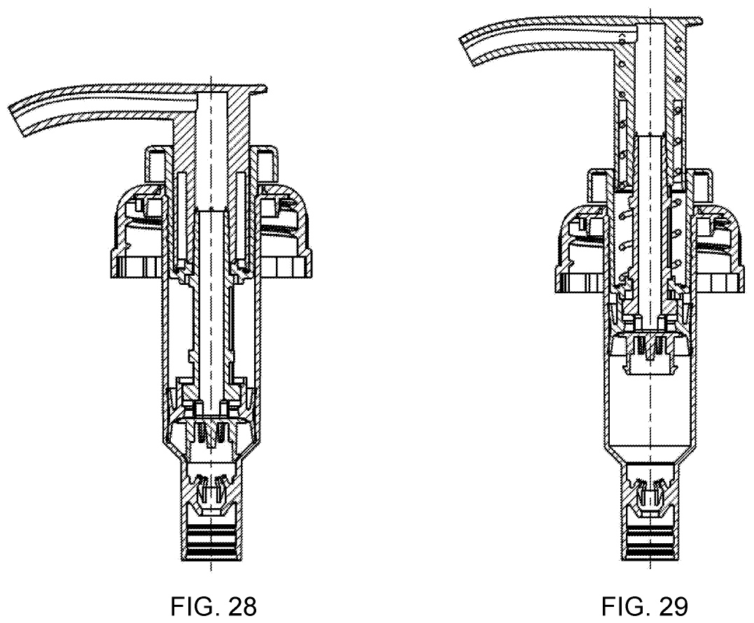

FIGS. 28 to 33 show a fourth embodiment. As in the third embodiment, the plunger stem has a discrete lower stem portion carrying the uplock and downlock formations, for ease of moulding. The plunger head is relatively simple, with a single downward skirt engaged by a water-resisting inward sealing bead around the mouth of the insert component. As seen above, the bottom end of this plunger skirt makes an outward seal against the inside of the insert component. As in the third embodiment, the cylinder body is sufficiently short above its bottom convergence that in the down position, it pushes the sliding seal up into its closed position relative to the outlet windows.

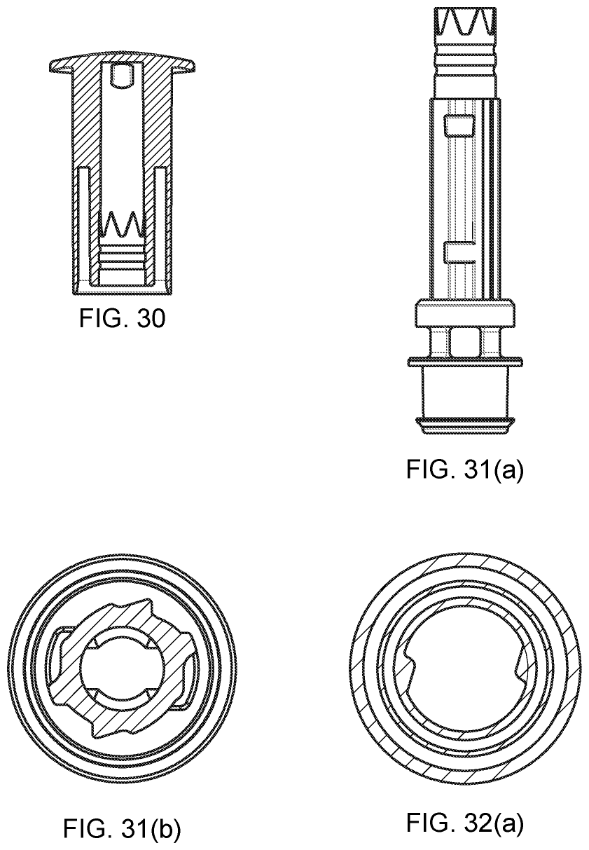

FIGS. 30 and 31 show the integrated head and upper stem portion (FIG. 30) and the lower stem portion (FIG. 31), including axially toothed interlocking formations above the snap ribs so that they are rotationally locked.

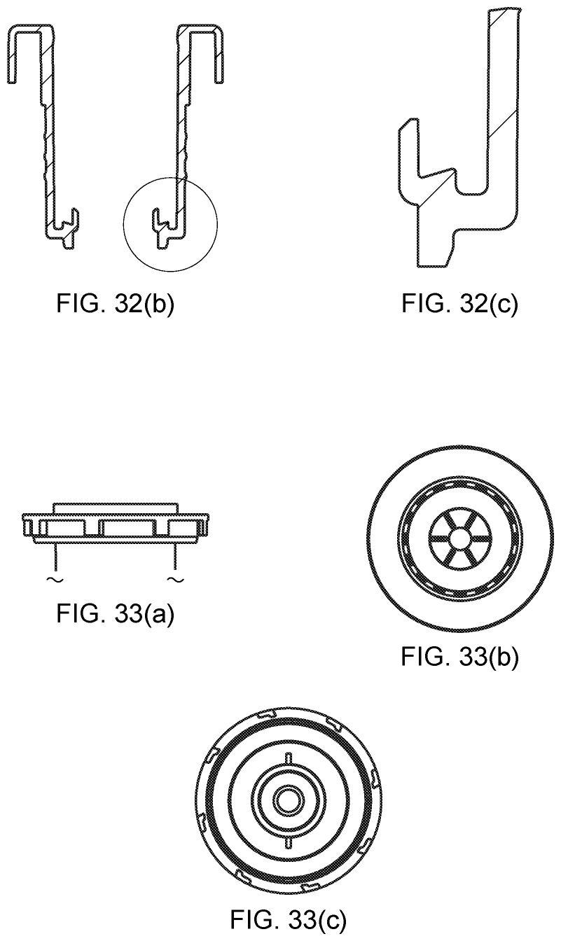

A particular feature in this embodiment is the transfer of more of the uplock/downlock functionality to the exterior of the plunger stem, rather than the interior of the insert component. Thus, the insert component (FIG. 32) has a pair of simple uplock/downlock lugs which are simply shaped, with flat top and bottom surfaces (see also FIGS. 28, 29), a steeply-inclined stop face directed clockwise, and a gently-inclined ramp face directed anti-clockwise, and a rounded inward tip. Otherwise, the inner face of the insert is a plain cylinder.

The stem exterior carries an upper downlock projection and a lower uplock projection, one above the other and of similar form, with flat axially-directed abutment surfaces which, in the locked positions, engage above or below the locking lugs of the insert. In addition, the plunger stem has a radially-projecting stop formation at one (circumferential) end of each abutment, shaped to fit against the steep stop face of the insert lug, and a more gently-inclined stop formation facing in the opposite direction about one quarter turn away from the lug. These formations are repeated on opposite sides of the stem, as before. Moreover the stop formations and associated features—described below—are continuous up and down the stem which makes for ease of moulding and also provides for a good user action as now described.

Specifically, adjacent the locking turn stop formation (at one end of the lug on the stem) the stem surface has a recess i.e. a local reduction in diameter, approached by smooth surfaces. The lug of the insert fits into this recess, without interference. Adjacent the recess the diameter increases slightly, so that there is a larger-diameter land region between the turn stop for the lock position and the turn stop for the unlock position (which as mentioned is about a quarter-turn or third-turn away). Adjacent the turn stop for the unlock position, there is again a slight diameter reduction recess in which the insert lug fits without interference. Between these positions however there is appreciable interference between the rounded tip of the insert lug and the raised land on the stem surface, so that when the plunger is turned and reaches one of the stop positions, the user feels an appreciable relaxation, click or settling into the defined position. This tactile reinforcement assists the user to feel confidence in the positions of the plunger. Since the recesses continue up and down the stem, they provide a guide for up and down movement of the plunger without rotation so that the plunger does not accidentally shift between the locked and unlocked positions, and rises and falls freely in use unless deliberately turned. The stem surface can easily be moulded with smoothly curving surfaces providing these features so that the parts can turn freely and without damage even when there is radial interference.

FIGS. 32(e), (c) show a further refinement. The spring seat region at the bottom of an insert has an inwardly-inclined or conical surface, with a raised outer edge which prevents sideways or outward displacement of the spring during its movement. This is an independent proposal herein and helps to ensure free movement of the plunger skirt opened to down the interior of the body insert. See also FIGS. 28 and 29.

The fourth embodiment shows a different rotational lock formation for the underside of the closure part of the cylinder body and to engage the container neck (not shown). The formation shown has a set of eight downward projections, outwardly spaced from the inner sealing skirt as before. This is the feature disclosed in our GB1608596.1 filed on 16 May 2016, the disclosure of which is incorporated herein by reference. It is designed to cooperate with a container neck having an upward plug sealing skirt as before, and a pair of two opposed outward projections immediately below the skirt, to engage the body flange lugs shown. In addition to the usual thread, the container neck has directional pawls below the thread to engage flexible directional lugs which project in around the bottom periphery of the outer securing cap (see FIGS. 28 and 29) resulting in a very secure, tamper-resistant closure that will resist considerable agitation and impact e.g. during shipping, without damage or leakage.

1-10. (canceled)

11. A reciprocating dispenser pump having a locking mechanism to selectively prevent actuation of the pump and a tamper evident feature to indicate a first release of the pump from an initially locked position, the pump comprising:
a pump body having a body cylinder defining a pump chamber and an insert coaxially received by the cylinder body, and
a plunger having a head with a frangible extension protruding downward toward the pump body and a stem having one or more projections formed beneath, said stem extending coaxially through the insert with a lower end of the stem disposed in the pump chamber;
wherein the body cylinder includes a closure plate and at least one vent hole fluidically connected to the pump chamber and positioned within a sidewall of the body cylinder;
wherein the insert has: (i) a top surface with a groove positioned to receive the frangible extension and (ii) at least one downlock formation and, optionally, at least one uplock formation;
wherein the lower end of the stem includes a keying projection so that, when the plunger is rotated relative to the pump body, the keying projection cooperates with the downlock formation to prevent extension of the plunger away from the pump body when the plunger is in a specific rotational alignment with the insert; and
wherein the keying projection is initially engaged by the downlock formation so that the frangible extension is retained within the groove and, upon a first release of the keying projection from engagement with the downlock formation, a portion of the frangible extension detaches from the plunger to provide a tamper evident feature.

12. The pump of claim 11 wherein the lower end of the stem includes a turn stop projection positioned axially above and spaced apart from the keying projection, said turn stop projection cooperating with the insert to limit rotation of the plunger relative to the pump body.

13. The pump of claim 11 wherein the frangible extension is snap-fitted into the groove.

14. The pump of claim 13 wherein the groove is arcuate.

15. The pump of claim 13 wherein the groove includes a trap zone along a portion of the groove, said trap zone positioned relative to the specific rotational alignment so as to detach and retain the portion of the frangible extension after the first release.

16. The pump of claim 13 wherein the groove includes a top lip and the frangible extension includes a barb so that the top lip traps the barb within the groove after the first release.

17. The pump of claim 11 wherein two keying projections are positioned on opposing sides of the lower end of the stem.

18. The pump of claim 11 wherein the insert is formed to accommodate between five to ten discrete rotational alignments of the plunger and the pump body.

19. The pump of claim 11 wherein the closure plate includes inner and outer dependent skirts defining a channel to receive a container neck.

20. The pump of claim 11 wherein a movable piston is enclosed within the pump chamber, said piston selectively blocking the vent hole to control flow of compensation air when the pump is actuated.

21. The pump of claim 20 wherein a discrete end piece is positioned in the pump chamber along a bottom edge of the movable piston, said discrete end piece cooperating with an inlet valve to control flow of fluid flowing through and dispensed by the pump.

22. The pump of claim 11 wherein the plunger includes a downward skirt to sealingly engage the insert.

23. The pump of claim 11 wherein the lower end of the stem is attached to an upper end formed integrally with the head of the plunger.

24. The pump of claim 11 wherein a plurality of downlock formations and a plurality of uplock formations are provided on the insert.

25. The pump of claim 11 wherein the groove is provided in a flat collar, said flat collar integrally formed on the top surface of the insert.

26. The pump of claim 11 wherein the insert includes a floor which sealingly engages the lower end of the stem to define an upper portion of the pump chamber.

27. The pump of claim 26 wherein the floor serves as a seat for a biasing member, said biasing member urging the plunger into an extended position.
